(19) United States
(12) Patent Application Publication
(10) Pub. No.: US 2023/0070138 A1
(43) Pub. Date: Mar. 9, 2023

(54) SUPPORT SYSTEM AND APPARATUS FOR RAPID ASSEMBLY OF COMPONENTS AND INFRASTRUCTURES WITH INTEGRATED ELECTRONICS, POWER AND OTHER INSTRUMENTALITIES

(71) Applicant: Lenox Laser, Inc., Glen Arm, MD (US)

(72) Inventors: Joseph P. d'Entremont, Phoenix, MD (US); David S. Watson, Darlington, MD (US)

(73) Assignee: Lenox Laser, Inc., Glen Arm, MD (US)

(21) Appl. No.: 17/986,270

(22) Filed: Nov. 14, 2022

Related U.S. Application Data
(63) Continuation of application No. 17/670,980, filed on Feb. 14, 2022, now abandoned.
Application No. 17/670,980 is a continuation of application No. 15/692,731, filed on Aug. 31, 2017, now abandoned.
Application No. 15/692,731 is a continuation-in-part of application No. 14/824,742, filed on Aug. 12, 2015, now abandoned.
(60) Provisional application No. 62/036,567, filed on Aug. 12, 2014.

(51) Int. Cl. F16L 3/10; B33Y 80/00

(52) U.S. Cl. CPC F16L 3/1025; B33Y 80/00; G02B 6/3652

(57) ABSTRACT

A system of interlocking blocks and rods or tubes for rapid assembly of component infrastructures, where one or more of those components have electronics, power or other instrumentalities built into the component during manufacture, such as by 3-D printing, and the components thereof and methods therefor. The rods or tubes, blocks (for interlocking the rods/tubes) and through-holes allow not only structural stability but interconnectivity of electricity, power or other functionalities. The methodology of the present invention provides a paradigm for modeling more costly and complicated systems. Also, product packaging for products made pursuant to the present invention is scaled so as to be usable in the application of the parts.

### CROSS REFERENCE TO RELATED APPLICATIONS

The present invention is a continuation of pending U.S. Pat. Application Serial No. 17/670,980, filed Feb. 14, 2022, which is a continuation of U.S. Pat. Application Serial No. 15/692,731, filed Aug. 31, 2017, which is a continuation-in-part of U.S. Pat. Application Serial No. 14/824,742, all entitled “ SUPPORT SYSTEM AND APPARATUS FOR RAPID ASSEMBLY OF COMPONENTS AND INFRASTRUCTURES WITH INTEGRATED ELECTRONICS, POWER AND OTHER INSTRUMENTALITIES,” filed Aug. 12, 2015, which is based for priority on provisional U.S. Pat. Application Serial No. 62/036,567, entitled “ SUPPORT SYSTEM FOR RAPID ASSEMBLY OF COMPONENT FOR INFRASTRUCTURES WITH INTEGRATED ELECTRONICS, POWER AND OTHER INSTRUMENTALITIES,” filed Aug. 12, 2014, the subject matters of which are incorporated by reference herein.

### FIELD OF THE INVENTION

The present invention relates to general purpose component/equipment support systems and, more particularly, to an improved universal system of interlocking blocks and rods or tubing for allowing rapid prototyping of test assemblies, lab bench setups and other equipment infrastructures, including assemblies having components with built-in electronics, power and other instrumentalities.

The present invention also relates to the system properties of modularity, scalability and interfaceability extending to the packaging used to ship or deliver the systems and products envisioned and sold.

### BACKGROUND OF INVENTION

As noted at length in Applicant’s U.S. Pat. No. 5,659,652, during any experiment or project in basic or applied research, product development or assembly management, a preliminary and final test setup is required. These test setups inflate product development costs due to the material costs and man-hours that go into modeling and prototyping. Bench fixtures, components and equipment often need to be installed on a specific infrastructure and with tight tolerances. Traditionally, these infrastructures needed to be custom designed, custom manufactured, and permanently assembled. This required a separate design facility (e.g., CAD design), a manufacturing facility, and an assembly facility. In order to facilitate the necessary adjustments yet maintain the proper tolerances, each component of the supporting infrastructure must usually be custom designed, manufactured and assembled. The cost is enormous and unduly inflates the ultimate product cost. Moreover, significant time is wasted waiting for custom parts and fixtures and in assembling the experimental infrastructure. Once assembled, the custom fixtures do not lend themselves to modification and re-tooling. Any changes to the infrastructure sends it back to the design facility where the process must be repeated. Traditionally, an extraordinarily large portion of the ultimate product cost was devoted to the test infrastructure. But these single-purpose (task-specific) custom fixtures usually have no usefulness after the product development stage and are discarded.

Accordingly, there would be great economies in a universal system which could increase productivity and reduce costs by allowing such fixtures, models and prototypes to be assembled in a short time from a small inventory of standardized parts, thereby shortening the design and fabrication lead time and expense, and allowing easy modification, adjustment and re-tooling.

Additionally, experience selling the system made pursuant to the Applicant’s prior patent shows that some portion of the sales go to people who used the system to construct toys. Applicant has realized that the packaging used for the product is scaled in size like the parts of the system themselves. By adding markings showing hole locations, cut lines and so on the packaging may be used in conjunction with product itself in the construction of toys or other low-stress items.

Of course, the broader concept of construction via standard components has been used in other unrelated applications. For example, U.S. Pat. No. 2,493,435 issued to Archambault is directed to a set of toy building blocks (see column 1, lines 3, 4). The fundamental units of the Archambault system are cubes (see column 2, lines 23, 24, 25), and inter-fitting rods that “hold together a structure built from the blocks” (column 5, lines 28, 29). The rods are secured to the cubes by a frictional fit, and a fabricated structure will appear as an assembly of interfaced cubes with hidden rods. This is targeted for entirely different application. The rod and cube layout and dimensions are not calculated to provide a framework to support anything, and the system is not capable of providing reliable nor adjustable support for equipment.

Nevertheless, as described in Applicant’s earlier patent, incorporated herein by reference, it would be greatly advantageous to carry the concept over into equipment support infrastructures. With structural modifications and refinements, this goal is herein achieved to provide a universal system capable of allowing fixtures, models and prototypes to be assembled in a short time from a small inventory of standardized parts, e.g., through a variety of interfaces. Design and fabrication times can be slashed, and easy modification, adjustment and re-tooling becomes possible.

It is also advantageous to take advantage of new manufacturing techniques and advances in the material sciences, only recently available, that permit taking the paradigm of Applicant’s earlier patent to a new level. For example, the unique possibilities of 3-D printing, and the admixture or integration of electronics, power conduits and other devices and instrumentalities into the materials used for structure, allow an even greater degree of flexibility and functionality.

It is, therefore, an object of the present invention to provide a cost-effective system for building equipment infrastructures, including an array of standardized parts to facilitate, for example, the rapid prototyping, testing and design of systems through the incorporation of instrumentalities, power conductance, electronic pathways, interfacing capabilities and more during manufacture, such as 3-D printing of each component.

It is a further object of the present invention to provide improved instrumentalities for the simulated creation and demonstration of systems and system components through the apparatus of the present invention.

It is also an object of the present invention to extend the improvements of the instrumentalities to the packagings thereof, such as with toy products.

### SUMMARY OF THE PRESENT INVENTION

The invention generally relates to a system of interlocking cubes or blocks and rods or tubes for rapid assembly of component infrastructures, where one or more of those components have electronics, power or other instrumentalities built into the component during manufacture, such as by 3-D printing, and the components thereof and methods therefor. The rods or tubes, cubes or blocks (for interlocking the rods/tubes) and through-holes allow not only structural stability but interconnectivity of electricity, power or other functionalities. The methodology of the present invention provides a paradigm for modeling more costly and complicated systems. Also, product packaging for products made pursuant to the present invention is scaled so as to be usable in the application of the parts.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying DRAWINGS, where like reference numerals designate like structural and other elements, in which:

FIG. 1 is a representative configuration of components incorporating the principles of the present invention;

FIG. 2 is a representative view of various components having holes and openings therethrough incorporating the principles of the present invention;

FIG. 3 is representative view of various pegs with interconnecting rods and pipes pursuant to the teachings and principles of the present invention;

FIG. 3A illustrates an exemplary embodiment of the interconnectability of the constituent components into a first illustrative configuration pursuant to the teachings of the present invention;

FIG. 3B illustrates an exemplary embodiment of the interconnectability of the constituent components into a second illustrative configuration pursuant to the teachings of the present invention;

FIG. 3C illustrates an exemplary embodiment of the interconnectability of the constituent components into a third illustrative configuration pursuant to the teachings of the present invention;

FIG. 3D illustrates an exemplary embodiment of the interconnectability of the constituent components into a fourth illustrative configuration pursuant to the teachings of the present invention;

FIG. 3E illustrates an exemplary embodiment of the interconnectability of the constituent components into a fifth illustrative configuration pursuant to the teachings of the present invention;

FIG. 3F illustrates an exemplary embodiment of the interconnectability of the constituent components into a sixth illustrative configuration pursuant to the teachings of the present invention;

FIG. 4 is a representative view of various cubes or blocks offering interconnectivity and functionalities pursuant to the present invention;

FIG. 5 is a representative view of exemplary interconnectivity and functionalities pursuant to the present invention in a first embodiment including computer or processor components;

FIG. 6 is a representative view of exemplary interconnectivity and functionalities pursuant to the present invention, as shown in FIG. 5, in a second embodiment including various electronic-based components; and

FIG. 7 is a representative view of exemplary interconnectivity and functionalities pursuant to the present invention, as shown in FIG. 6, in a further embodiment.

### DETAILED DESCRIPTION OF THE PRESENT INVENTION

The present invention will now be described more fully hereinafter with reference to the accompanying DRAWINGS, in which preferred embodiments of the invention are shown. It is, of course, understood that this invention may, however, be embodied in many different forms and should not be construed as limited to the embodiments set forth herein; rather, these embodiments are provided so that the disclosure will be thorough and complete, and will fully convey the scope of the invention to those skilled in the art. It is, therefore, to be understood that other embodiments can be utilized and structural changes can be made without departing from the scope of the present invention.

The present invention is generally directed to improved apparatuses, systems, processes and techniques for usage in the manufacture and usage of modular and scalable framing components, particularly components that incorporate active signals and power therethrough. Additionally, through recent 3-D printing techniques, peg style connectors, rods, piping and boxes can be configured to interconnect physically and, by virtue the enhancements of the present invention, the components can interconnect in other ways also, providing new interfaces and functionalities, such as electronics and power connectivities.

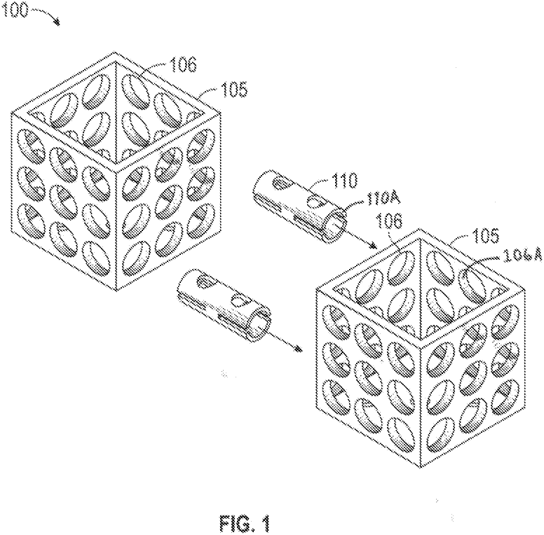

With reference now to FIG. 1 of the DRAWINGS, there is illustrated a representative configuration of an interconnection embodiment pursuant to the teachings of the present invention, generally designated by the reference numeral 100. As illustrated, support blocks or cubes, generally designated by the reference numeral 105 (shown without a cap or top), may be interconnected via pegs or a slotted pipe, such as generally designated by the reference numeral 110, which insert into respective holes in the support blocks, generally designated and illustrated by the reference numeral 106, with an exemplary directionality illustrated by the arrows. Also shown are interface portions 106A and 110A on engagement surfaces of the support blocks 106 and the pegs 110, respectively. As noted hereinabove and in Applicant’s earlier patent, the present invention offers an ease of configurability and simplification of the process, permitting rapid prototyping of many structures through modularity of components.

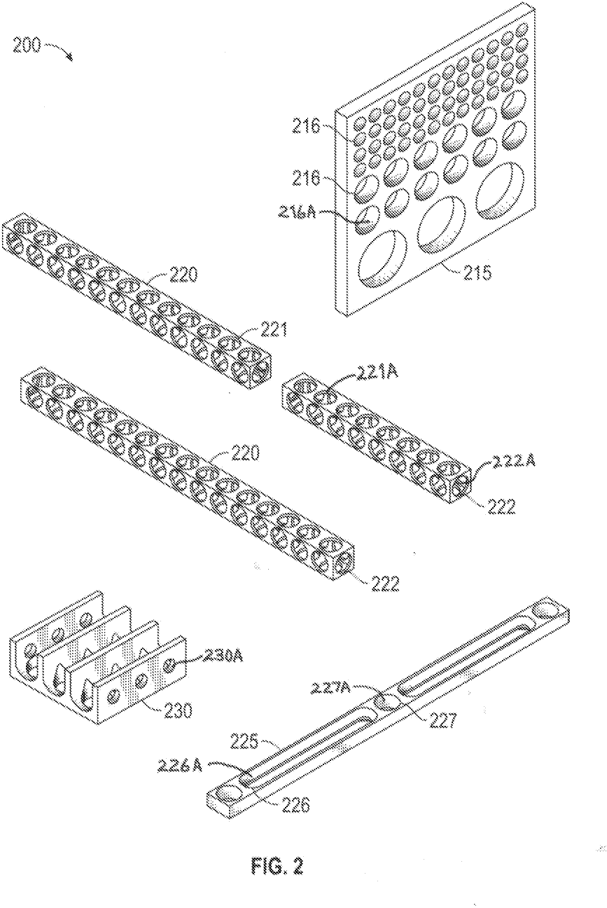

With reference now to FIG. 2 of the DRAWINGS, there are shown a variety of additional components manufacturing pursuant to the teachings of the present invention, generally designated by the reference numeral 200. As illustrated, a plate, generally designated by the reference numeral 215, has a number of illustrative, variably-sized holes therethrough, generally designated by the reference numeral 216. Additionally, each said hole 216 may have an interface for engagement with the interface 110A for peg 110 or other interface, generally designated by the reference identifier 216A. As noted, the holes can be equally spaced, and can form a grid-like system. It should be understood that the holes 216 may be ¼" holes spaced 5/16" on center, ½" holes spaced ⅝" on center, 1" holes spaced 1.25" on center, and so forth. It should also be understood that the holes may be re-sized at any multiple, e.g., ½ or 2 times, such as 0.25" > 0.5" > 1" > 2", as is understood in the art. It should, of course, be understood that through current 3-D printing techniques and other advances in the materials sciences, these holes can be more closely packed than before, yet the component 215 retaining sufficient structural strength for physical support.

With further reference to FIG. 2, there are also shown a number of frames, generally designated by the reference numeral 220, having regularly-spaced holes therethrough, generally designated by the reference numeral 221. As discussed, the frames 220, as well as the plate 215 and other components discussed herein, manufactured by 3-D printing (or otherwise) may have electronics or power conduit built into the component, thereby providing not only physical structure but electronic as well, as illustrated further hereinbelow. As noted in FIG. 2, the end portions of the frames 220 preferably have rounded holes, generally designated by the reference numeral 222, to receive therein rounded pegs and such, as described hereinbelow, or be received or fit entirely in square holes of another component, as also described in more detail hereinbelow. Also, as discussed, the aforementioned holes 221 and 222 preferably have respective interfaces for the engagement of the frames 220 to other interfaces, as described hereinabove and generally designated herein by the reference identifiers 221A and 222A, respectively.

Also shown in FIG. 2 are slot devices, generally designated by the reference numeral 225, which have slots and holes therethrough, generally designated by the reference numerals 226 and 227, respectively. Also, as described hereinabove, the device 230 as illustrated has a number of holes therethrough, each of which could have the aforementioned interfaces, generally designated by the reference identifier 230A. Additionally, a U-channel device, generally designated by the reference numeral 230, may also be constructed pursuant to the teachings of the present invention. Both the slot device 225 and the U channel device 230 may have communications, power or other pathways built into the structures, as discussed in connection with the aforesaid various embodiments of the present invention, and as described in more detail hereinbelow in connection with further embodiments of the present invention. Further, the slots 226 and the holes 227 of this embodiment may likewise include additional interfaces, generally designated by the reference identifiers 226A and 227A, respevctively.

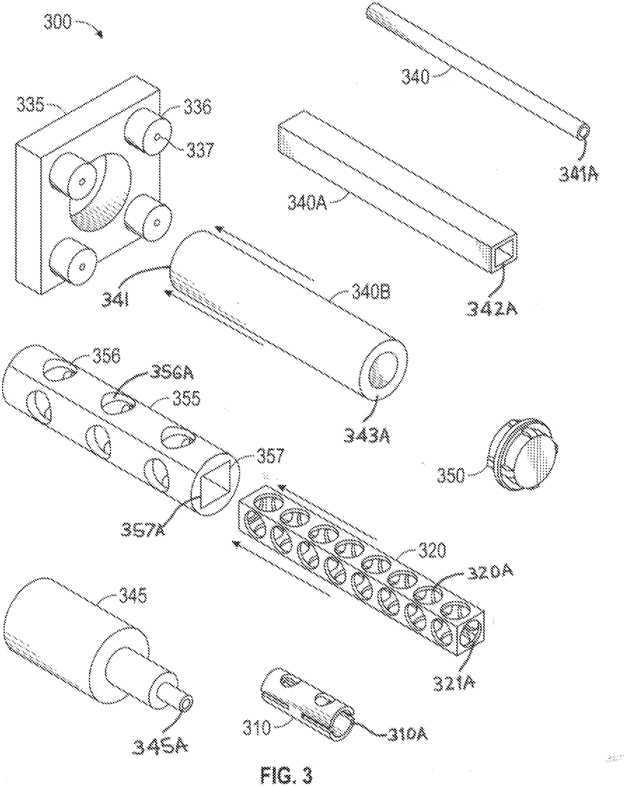

With reference now to FIG. 3 of the DRAWINGS, there are shown a variety of other components manufacturing pursuant to the teachings of the present invention, generally designated by the reference numeral 300. In this assemblage of components there is shown a base, generally designated by the reference numeral 335, with a number of pegs thereon, generally designated by the reference numeral 336, which are configured to engage rods, a range of sizes for which are generally designated by the reference numeral 340. It should be understood that the rods 340 can be circular or in another embodiment square, rectangular or square such as rod 340A, as shown in FIG. 3 and described further hereinbelow. As is also noted at length in Applicant’s earlier patent, pegs 336 are employed to attach blocks or modules together. Further, using the principles and techniques of the present invention, the pegs 336, in addition to structural support may also pass signals and power between modules, e.g., through pathway intersections built into the rods 340, such as through interfaces, generally designated by the reference numeral and identifiers 337, 341A, 342A and 343A, which provide the requisite electronic pathways and/or power interconnectivities necessary for a given prototype configuration.

As also shown in FIG. 3, a given rod 340B has a divot or hole, generally designated by the reference numeral 341, at the end, sized sufficiently and deep enough to receive the aforementioned peg 336, as is understood in the art and as shown by the arrows. As discussed, the rods 340 have receptors or other interfaces, such as 341A, 342A and 343A as described, for receiving the aforesaid signals, power or other pathways from the peg 336, such as engaging interface 337, thereby passing the signals and/or power along to another module. In addition to electronic and power interconnectivities, it should be understood that the pegs 336 can be employed to modularly scale down (or up) connections, e.g., from 1" to ½", as generally illustrated by the stepdown component with reference numeral 345, and also includes openings for a ⅝" square formation, and an interface 345A. Also shown is a cap, generally designated by the reference numeral 350, which may be employed to cover an end of the rod 340, such as rod 340B, thereby shielding the rod, which, as discussed, may have live power connected thereto, and otherwise closing any pathways through the rod 340.

With further reference to FIG. 3, there is shown a pipe, generally designated by the reference numeral 355, which has holes therethrough along the sides and a square hole at the end thereof, generally designated by the reference numerals 356 and 357, respectively with respective interfaces 356A and 357A. It should be understood that the square hole 357 is preferably sized to engage, for example, the aforedescribed frames, generally designated in FIG. 3 by the reference numeral 320, as demonstrated by the arrows. As discussed, each of the holes in the frame 320 may have interfaces for engagement, such as interface 321A to engage interface 357A, as well as a number of side interfaces, generally designated by the reference identifier 320A, as illustrated. Also shown is another slotted pipe, generally designated in FIG. 3 by the reference numeral 310, which may be employed to engage other interfaces, and provide structural support, as well interconnectivity through an interface 310A, as described hereinabove.

With reference now to FIGS. 3A-3F, there are illustrated various embodiments of configurations of the aforementioned frames 320, as well as the pipes 355, when interconnected and interfaces conjoined, illustrating some of the potential configurations of these components for use in the aforementioned modeling or prototyping. As shown in FIG. 3A, a T-configuration is shown, generally designated by the reference numeral 320A. As shown in FIG. 3B, a three corner configuration is shown, generally designated by the reference numeral 320B. As shown in FIG. 3C, a branch configuration is shown, generally designated by the reference numeral 320C. As shown in FIG. 3D, a cross configuration is shown, generally designated by the reference numeral 320D. As shown in FIG. 3E, a four branch configuration is shown, generally designated by the reference numeral 320E. Finally, as shown in FIG. 3F, a five branch configuration is shown, generally designated by the reference numeral 320F. As shown, there are a variety of open interfaces, each of which are generally designated by the reference identifier 321A. It should, of course, be understood that the illustrated configurations are exemplary and numerous other interconnections pursuant to the teachings of the instant invention are possible and covered by the instant disclosure.

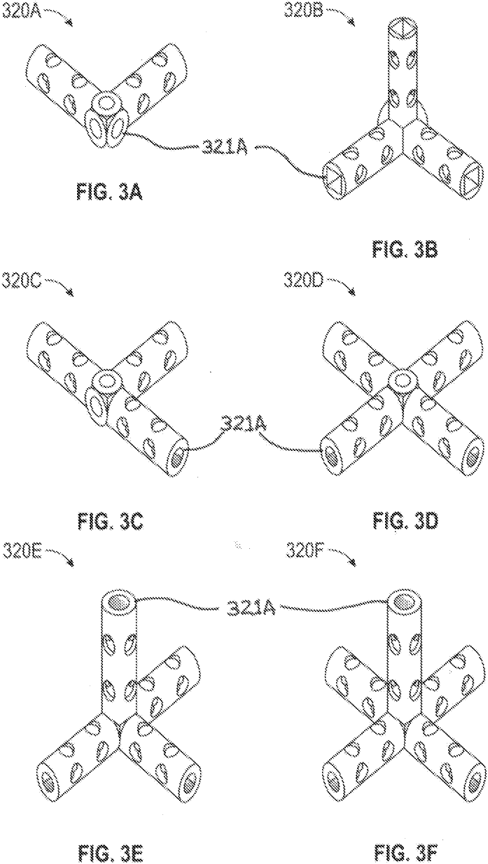

With reference now to FIG. 4 of the DRAWINGS, there are shown a variety of cube, block and module components manufacturing pursuant to the teachings of the present invention, generally designated by the reference numeral 400. It should, of course, be understood that the various cube or block containers illustrated, generally designated in FIG. 4 by the reference numeral 405, can be used to house components and electronics, and can employ a variety of the aforementioned peg connectors 336 and rods 340 to interconnect other cubes, forming a larger construct in a rapid prototyping scenario or other context, as described and as shown by the arrows. Also, as described hereinabove, the variety of holes shown may have respective interfaces, generally designated by the reference identifiers 405A and 460A. Also, the various cubes 410 can be modularly designed to allow different faces or covers, generally designated by the reference numeral 460, each easily swapped, providing alternate interfaces and functionalities.

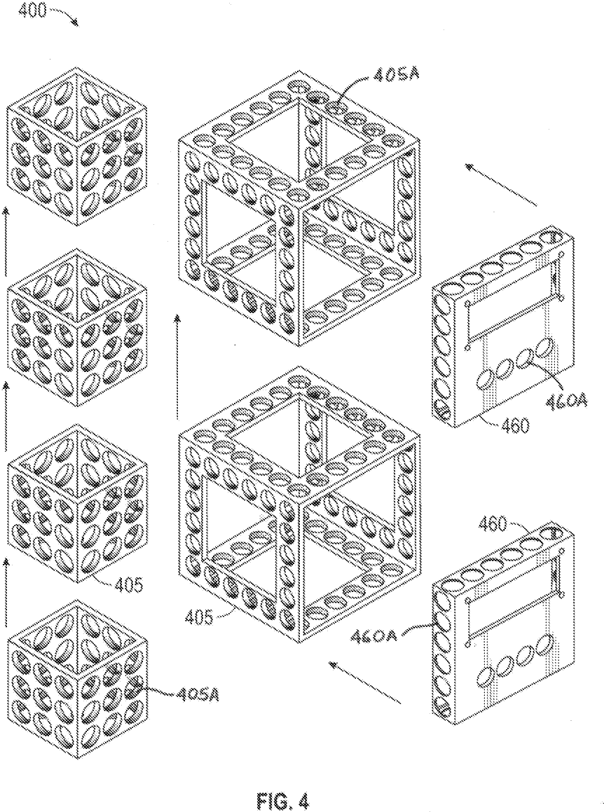

With reference now to FIG. 5 of the DRAWINGS, there is shown an exemplary configuration for electronics connectivity pursuant to the teachings of the present invention. As described and discussed hereinbefore, the present invention permits the construction of systems having a variety of constituent parts or modules. The present invention, as discussed, is directed to the more efficient and more realistic paradigm for the construction of prototype systems employing power and electronics for the modeling of actual systems. Shown in FIG. 5 is an example of a subcomponent, generally designated by the reference numeral 565 being conjoined or connected to a larger component, generally designated by the reference numeral 570. In this embodiment, the subcomponent 565 may be a cover, such as illustrated and described in connection with cover 460 in FIG. 4, and the larger component may be a cube, such as shown and described in connection with cube 405 in FIG. 4 or with cube 105 in FIG. 1. As indicated by the arrow, the subcomponent or submodule 565, containing an electronics component, such as a PC board, generally designated by the reference numeral 575, is connected to the other component 570, whereby the combined assembly has the electronics capabilities of component 575.

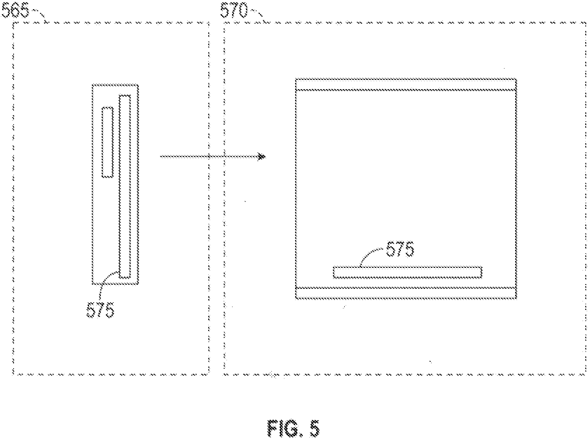

With reference now to FIG. 6 of the DRAWINGS, there is shown a further exemplary system configuration of subcomponents pursuant to the teachings of the present invention, and generally designated by the reference numeral 600. As discussed, described and illustrated in connection with FIG. 5, the configuration directions shown in FIG. 6 can be exemplified by a cover 660 being attached to a cube module, generally designated by the reference numeral 670. The assembly thereof, as illustrated by the arrows, unites the two components both physically and electronically and/or power wise, e.g., through respective electronic interfaces, generally designated by the reference identifiers 660A and 670A, as described hereinabove. An electronic component, generally designated by the reference numeral 675, such as a PC board, is configured as part of the cover 660. Also shown is a button interface, generally designated by the reference numeral 680 with a toggle 681. The button interface 680 connects to the PC board 675, as illustrated by the arrow, and the toggle extends through a hole in the cover, generally designated by the reference numeral 661. Upon assembly, a user of the prototype configuration can turn the electronics component 675 on and off with the toggle switch 681. Electronic conduits or pathways, such as along the edges of the cube 670, provide connectivity of the submodule component 660 throughout the main component 670, and permit interconnectivity with adjacent modules, as described.

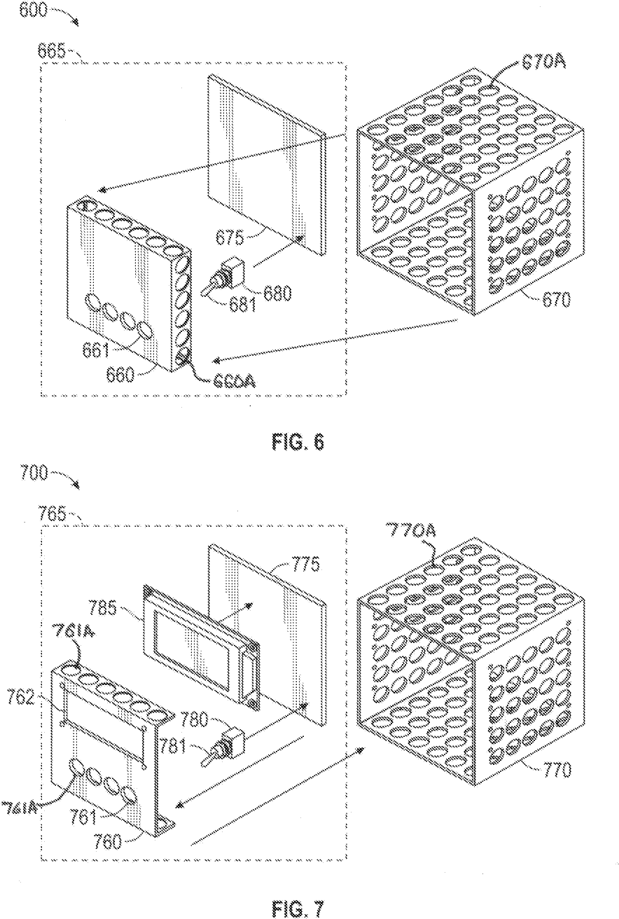

With reference now to FIG. 7 of the DRAWINGS, there is shown another exemplary system configuration of subcomponents pursuant to the teachings of the present invention, and generally designated by the reference numeral 700. As discussed, described and illustrated in connection with FIG. 6 hereinabove, another electronic component, such as an LCD display, generally designated by the reference numeral 785, is employed. The new component 785 preferably fits through a hole 762 in cover 760, and also attaches to the PC board, as is understood in the art. As with the configuration shown in FIG. 6, the assembly of the various components and modules, components 765 and 770, as shown by the arrows, results in another, exemplary prototype configuration pursuant to the teachings of the present invention, which elegantly and simply combines and integrates electronic and/or power functionalities and capabilities with the physical system. Also, respective interfaces 761A and 770A provide the requisite interconnectivity between the two components.

As shown in the figures above, the pegs 336, rods 340 and frames 220 are configured to engage via round- or square-shaped receiving portions. With the cubes 105/670/770 and other surfaces having a plethora of holes, the rods 340 can engage in a variety of ways to provide stability and functionality, e.g., a specially-configured rod with electronic and/or power conduits can engage a particular peg 336 to carry the electronic pathways and/or power from the peg 336 to another peg or other receiver elsewhere, e.g., in another cube 105/670/770 adjacent thereto and having the aforementioned interfaces to receive and further transmit the electronic signals and/or power. It should be understood that the size and shapes of the pegs 336 are adjustable. As discussed hereinabove, one or more of the holes or engagement surfaces of these components are equipped with an interface to lock or otherwise secure the components together.

As indicated, the present invention is directed to smart configurations that provide both structural stability and other functionalities. For example, the components of the present invention, as illustrated and described hereinabove, as well as all similar such configurations, may incorporate additional electronics therein, e.g., instead or with the interface 680 include wireless technology therein, such as Bluetooth, Wi-Fi, radio frequency and other such capabilities, a huge enhancement over the art, including Applicant’s prior patent. Indeed, the present invention represents a paradigm shift in modular configurability possibilities.

For example, the integration of microelectronics and/or other pathways into the various components creates a form of molecular thinking with infinite variability.

As indicated, through recently-developed 3-D printing and other more recent techniques, components can now be manufactured with more holes, without compromising material strength, and through techniques quite different from the prior art approaches. For example, as existing techniques are subtractive, the process for creating holes and such are limited by the techniques of today. With the additive approaches of 3-D printing, however, materials and components can be manufactured with different constraints, offering a wider range of structural and functional capabilities not available to the prior art. Through scalability and other approaches, the principles of the present invention can be employed in a wider range of contexts than the prior art, offering substantial enhancements to existing techniques.

For example, in addition to the aforementioned rapid prototyping advantages of the present invention, the packaging of products may also employ aspects of the present invention. In some areas, such as in toy packaging, where scaling applies to varying toy sizes, the usage of markings, cut lines, holes and other indicia on the packaging, corresponding to the varying product size, may be employed to not only prototype the ultimate product, but also package that product.

It should be understood that some of the aforementioned components (rods, tubes, blocks, and cubes) can be made from a wide variety of materials. For example, abs/pla (plastics), stainless steel, brass, platinum (metals), ceramics, etc. are used in 3D printing technologies and can further lead to the rapid creation of such components/infrastructures and systems. Additional materials that may be employed include glass, plastic, and metals which can be used in rods for liquid/gas transfer, support and conduit. Blocks and cubes can be made of any substrate/material that can be 3d printed, machined, or extruded. It should be understood that the above description of materials is not exclusive and other materials, whether used by 3D printing or traditional manufacturing techniques are possible and within the realm of the present invention.

The previous descriptions are of preferred embodiments for implementing the invention, and the scope of the invention should not necessarily be limited by these descriptions. It should be understood that all articles, references and citations recited herein are expressly incorporated by reference in their entirety. The scope of the current invention is defined by the following claims.

What is claimed is:

1. A support system for rapid assembly of component infrastructures, comprising:
a plurality of connectors, each said connector having electronic interfaces at the respective ends thereof; and
a plurality of supporting blocks, at least one of said supporting blocks having a hole therethrough configured to receive at least one of said connectors to form an assembly thereof,
wherein for at least one of said plurality of supporting blocks each said hole through said at least one supporting block has an electronic interface,
wherein said at least one of said connectors and said at least one of said supporting blocks, when conjoined at the respective interfaces, form a conduit pathway.

2. The support system according to claim 1, wherein said conduit pathway is selected from the group consisting of electronic signals, power and combinations thereof.

3. The support system according to claim 1, wherein said connectors are selected from the group consisting of rods, frames, tubes, pipes, slotted pipes, step-down components, step-up components, pegs, covers, slot devices, U channels and combinations thereof.

4. The support system according to claim 3, wherein said connectors have an interface configured to engage a respective supporting block, forming, upon conjoinment, said conduit pathway therebetween.

5. The support system according to claim 3, wherein said frames interconnect to each other.

6. The support system according to claim 3, wherein said frames interconnect within respective pipes.

7. The support system according to claim 6, wherein said frames have a square configuration, and said pipes have a square hole to receive a respective frame therethrough.

8. The support system according to claim 3, wherein said rods have a cylindrical, rectangular or square cross-section, a respective support block having respective holes therethrough configured to receive said rods.

9. The support system according to claim 3, wherein said at least one of said pegs comprises a peg conduit pathway therethrough, said peg, upon conjoining with a rod, tube or pipe at one end thereof, linking with connector pathways threrethrough, forming said conduit pathway.

10. The support system according to claim 1, wherein said supporting blocks are selected from the group consisting of cubes, plates, bases and combinations thereof.

11. The support system according to claim 10, wherein two cubes are interconnected by at least one of said connectors, forming said conduit pathway therebetween.

12. The support system according to claim 10, wherein a cube is interconnected with a cover, said cover, when conjoined with said cube, providing said conduit pathway.

13. The support system according to claim 10, wherein said supporting blocks have an interface configured to engage a respective connector, forming said conduit pathway.

14. The support system according to claim 10, wherein said supporting blocks have a plurality of holes therethrough.

15. The support system according to claim 14, wherein said plurality of holes vary in size.

16. The support system according to claim 1, wherein said connectors and supporting blocks are manufactured by 3-D printing or another additive manufacturing technique.

17. The support system according to claim 1, wherein said connectors and supporting blocks are scalable.

18. The support system according to claim 17, further comprising packaging for a product corresponding to the scalable configuration.

19. The support system according to claim 1, further comprising:
at least one cap, said at least one cap configured to cover a connector at one end.

20. The support system according to claim 1, wherein a plurality of conduit pathways are formed with the conjoinment of said connectors and said supporting blocks.
